(19) United States
(12) Patent Application Publication
(10) Pub. No.: US 2016/0158772 A1
(43) Pub. Date: Jun. 9, 2016

(54) ROTATING SPRAY NOZZLE

(71) Applicants: Robert KUYKENDAL, High Ridge, MO (US); Ronald DEICHMANN, High Ridge, MO (US)

(72) Inventors: Ronald S. Deichmann, House Springs, MO (US); Robert L. Kuykendal, High Ridge, MO (US)

(21) Appl. No.: 14/906,204

(22) PCT Filed: Jul. 18, 2014
(86) PCT No.: PCT/US2014/047266

§ 371 Date: Jan. 19, 2016

Related U.S. Application Data
(60) Provisional application No. 61/856,448, filed on Jul. 19, 2013.

(51) Int. Cl. B05B 1/20; B05B 15/06; B05B 3/04

(52) U.S. Cl. CPC B05B 1/20; B05B 3/04; B05B 15/062

(57) ABSTRACT

A rotating spray nozzle has a base, a water powered motor, an axle extending from the motor, an outer sleeve coaxial with the axle, a curvi-linear spray nozzle, and a pattern of holes in the spray nozzle. The invention also provides select bearings at key locations of rotation. The spray nozzle has a somewhat L shape formed of an upright and a leg generally perpendicular to the leg. The upright merges into the leg through a bend while the leg bends downwardly opposite the merge with the upright. Installed upon the axle, the leg cants the spray nozzle so that the to upright attains a 45° orientation to a horizontal plane. The invention rotates the spray nozzle at approximately 5 revolutions per minute to approximately 75 revolutions per minute.

### CROSS-REFERENCE TO RELATED APPLICATION

This non-provisional application claims priority to the pending Patent Cooperation Treaty (PCT) application PCT/US2014/047266 filed on 18 Jul. 2014 which claims priority to the provisional application 61/856,448 filed on Jul. 19, 2013 and all of which are owned by a common inventor.

### BACKGROUND OF THE INVENTION

The rotating spray nozzle generally relates to water sprayers, and more specifically to a sprayer at a location frequented by people.

For millennia, water has attracted people. People have played in waters of all kinds: streams, rivers, waterfalls, ponds, lakes, oceans, and pools to name a few. Away from those water bodies, people have developed water parks of all description. The water parks have pools, slides, dumping buckets, sprayers, fountains, and other features. Sometimes, a water park does have a location near a natural body of water. People have sought to replicate various natural features in the water parks.

With the dispersal of people from city centers to suburbs, people own more and more houses with lawns. In the last century, people have developed lawns in suburban settings which has followed the deployment of irrigation on a large scale into agriculture. In olden days, a lawn represented land taken out of agricultural production thus, a lawn indicated a well off landowner. In present times, lawns generally come with homes as an effect of zoning for single family detached homes. Detaching of homes by family spaces apart houses leaving room for lawns. Lawns generally have various grasses as the predominant plant.

Grasses generally have a shallow root structure with thin narrow leaves extending above the ground surface. The roots extend downwardly up to an inch. In rainy locations and other moist places, lawns and their grasses remain green and pleasing to people with a minimum of effort. In drier locations, often with infrequent rains and higher temperatures, lawns and their grasses turn brown in the absence of rain and the presence of heat.

To combat the browning of lawns, people water lawns as best they can. Homeowners have various water dispersing devices available. to Sprinklers connected to hoses predominate as the water dispensing device of suburban home dwellers. Sprinklers come in many kinds, reciprocating, oscillating, spray nozzle, flat hose, and the like. Sprinklers generally remain upon the lawn and deliver water to a rectangular area with an oscillating sprinkler or to round area with a reciprocating sprinkler or whirl sprayer. Children have been known to play in sprinklers on a hot summer day.

Adults generally do not play in sprinklers on lawns per se. Adults generally partake of water mist from various misters at sporting events and other large gatherings. Adults also walk under various sprayers at water parks, often with a child related to the adult.

### DESCRIPTION OF THE PRIOR ART

Over the years, various sprayers and other features have appeared at water parks. The sprayers have descended from devices in the firefighting, irrigation, and lawn sprinkling industries. Prior art sprayers include nozzles that discharge a tight conical stream of water at pressure, showers from heads above a user, arcuate fountains from aimed discharges, piping having a hole pattern therein, and fountains extending upwardly from a walking surface among other things. Generally the sprayers and other features have a fixed location and known dispersal pattern of water from them.

Oscillating lawn sprinklers have a hollow arm with an hole pattern therein. A geared mechanism rotates the arm between two positions upon the pressure from the water source. The hole pattern disperses streams of water terminating along a line. In moving the arm, the streams of water then wet a rectangular area. The arm generally has support upon two ends from a frame tastefully decorated to blend with a lawn. A reciprocating sprinkler to has water discharged under pressure from a source. A biased head interrupts a water stream to make the sprinkles and various gearing turns the head at a slow speed and returns the head to a starting position at a higher speed. For home application, the reciprocating sprinkler has a ground level position. Some variants exist for an elevated sprinkler.

While the oscillating sprinkler wets a rectangular area, its arm requires support upon both ends. While a reciprocating sprinkler wets a round area, it discharges a powerful stream broken into sprinklers.

The present invention overcomes the difficulties of the prior art. The present invention includes a rotating spray nozzle that rotates upon one end while dispersion water through a pattern of holes in the nozzle. The nozzle has an elevated position so that an adult may approach the nozzle but remain beneath the arc of sprayed water. The invention wets a generally round area of a selected diameter.

### SUMMARY OF THE INVENTION

Generally, the present invention provides a rotating spray nozzle that has a base, a water powered motor, an axle extending from the motor, an outer sleeve coaxial with the axle, a curvi-linear spray nozzle, and a pattern of holes in the spray nozzle. The invention also provides select bearings at key locations of rotation. The spray nozzle has a somewhat L shape formed of an upright and a leg generally perpendicular to the leg. The upright merges into the leg through a bend while the leg bends downwardly opposite the merge with the upright. Installed upon the axle, the leg cants the spray nozzle so that the upright attains a 45° orientation to a horizontal plane. The invention rotates the spray nozzle from approximately 5 revolutions per minute to approximately 75 revolutions per minute.

To operate the invention, the base is installed upon a water source providing pressure to the water. The motor is placed within the base and the axle attached to the motor. The axle has a bearing upon it that fits within the base so that the axle turns freely. A sleeve is then placed over the axle and the sleeve connects to the base. The sleeve remains fixed during operation of the invention. The sleeve is generally perpendicular to a horizontal plane, that is, the axis of the sleeve is coaxial with the axis of rotation of the motor. Opposite the base, the sleeve has a bearing that connects to the leg. The leg then extends upwardly from the sleeve as it curves slightly outwardly, for approximately twice the width of the base. The leg then curves inwardly so it merges in a curve to the upright. The upright is generally perpendicular to the leg after the curve. The upright then extends outwardly from the curve but at a 45° orientation to a horizontal plane. The upright has a plurality of holes in a pattern spaced inwardly from the free end but stopping short of the curve. The spray nozzle is generally hollow for admission of water into and through it. Upon opening a valve to supply water to the invention, the motor turns the axle under the water pressure and exhausts the water into the axle upwardly to the spray nozzle. The water then passes through the leg and enters the upright. From the upright, the water exits the invention in a plurality of arcs rotated by the axle into a pattern that wets a round area beneath and around the spray nozzle.

There has thus been outlined, rather broadly, the more important features of the invention in order that the detailed description thereof that follows may be better understood and that the present contribution to the art may be better appreciated. The present invention also includes holes in an offset pattern along a portion of the length of the upright, various bends in the leg and the upright, a hollow connection between the axle and the leg, a rigid sleeve, and welded connection of the sleeve to the base. Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved rotating spray nozzle that avoids the disadvantages of the prior art.

Another object is to provide such a rotating spray nozzle that has operating components concealed.

Another object is to provide such a rotating spray nozzle that produces a spray pattern that dampens a round area.

Another object is to provide such a rotating spray nozzle that produces a spray pattern that generally falls vertically upon users from above.

Another object is to provide such a rotating spray nozzle that has a low cost of manufacturing so the purchasing water parks, landowners, and organizations can readily buy the invented nozzle through supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 illustrates a perspective of the present invention when installed;

FIG. 2 shows a partial sectional view of the present invention;

FIG. 3 provides a side view of the present invention;

FIG. 4 illustrates a top view of the invention; and,

FIG. 5 describes an end view of the arm of the invention.

The same reference numerals refer to the same parts throughout the various figures.

### DESCRIPTION OF THE PREFERRED EMBODIMENT

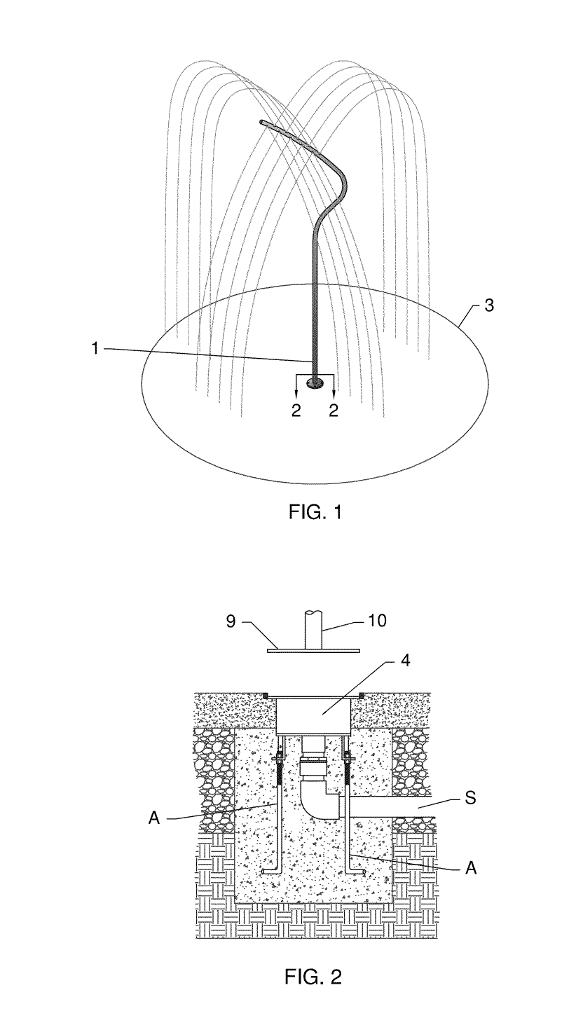

The present invention overcomes the prior art limitations and provides a rotating spray nozzle, typically for water parks, that gently provides a spray upon a typically area. Turning to FIG. 1, the present invention 1 is shown installed on a generally planar area, such as a portion of a water park or municipal aquatic center. The invention has a generally slender, elongated form perpendicular to the planar area. The invention discharges water from itself opposite the planar area. The discharge of water takes the form of a spray pattern as at 2. The invention rotates axially which turns the spray pattern simultaneously. As the spray pattern turns with the invention, the invention wets a portion of the planar area, here to shown as a circle. The circle has an outer diameter of approximately up to twelve feet. The outer diameter may fluctuate depending upon water pressure into the invention, wind direction, wind speed, and other environmental factors.

FIG. 2 then shows a partial sectional view of the invention 1 generally proximate its bottom, that is, in the planar area that becomes wet. The invention rests upon anchors A embedded into the planar area. The anchors are generally slender and elongated. Upon one end of the anchors, a water powered motor as at 4 connects. The water motor 4 receives pressurized water from a source S here shown as a pipe. The source often utilizes a municipal or other outside water supply that generally provides water pressure to the motor in the range of 10 pounds per square inch, psi, to about 200 psi. The motor 4 itself operates upon a flow of about 10 gallons per minute (g.p.m.) to about 60 g.p.m. and a pressure range of about 15 pounds per square inch (p.s.i.) to about 60 p.s.i. The source provides water, generally fresh and potable, for applications that contact people. Select motors and embodiments of the invention may receive salt water or non-potable water for application that do not contact people. The description continues based upon potable, fresh water introduced into the invention. The motor receives a base 9 upon it and generally opposite the entry of the source S into the motor 4. The base is generally planar and round as later shown. The base may connect by mechanical or chemical means to the motor or by welding. Extending from the general center of the base, the invention has its sleeve 10. This view shows a portion of the sleeve.

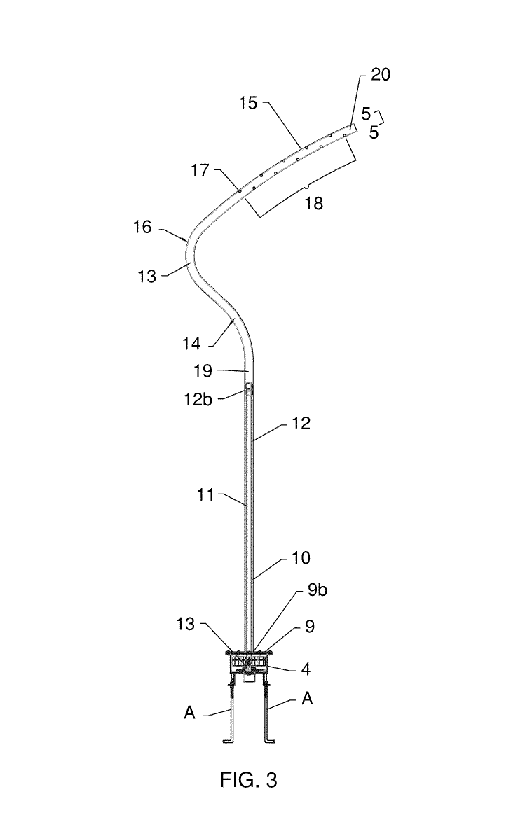

Then FIG. 3 shows a full height side view of the invention 1. The sleeve 10 is generally slender, elongated, and hollow. The sleeve extends well above the base 9. The base joins to the motor 4 upon the anchors as before. The base includes a rotating bearing 9b in communication with an axle 11 within the sleeve. Preferably, the bearing 9b is made of a brass alloy and alternatively of a copper alloy. The axle has an operative connection to the motor so that it receives rotational force. The axle turns freely in or upon the base as the sleeve remains fixed to the base. The axle is also slender, elongated, and hollow but with an outer diameter slightly less than the sleeve. Both the sleeve and the axle have a watertight construction so that water only passes through them axially. More particularly, the water passes through the axle as the axle turns within the sleeve. The axle receives water discharged from the motor. The axle has its length and the sleeve has its length and the axle is concentric within the sleeve. The axle and the sleeve have an orientation generally perpendicular to the motor, that is, extending upwardly from a surface of the installation, that is, a water park deck or other planar area. The axle rotates about its length, that is, along its longitudinal axis where the longitudinal axis is centered upon the motor.

The sleeve has a lower end 13 generally connecting to the base and an opposite upper end 12 locating away from the base. The upper end, when installed, has its position well above the base, approximately at least five feet. The upper end includes a swivel bearing 12b within the upper end and generally inserted into the axle opposite the motor. The swivel bearing allows passage of water through it while allowing the axle to continue its turning. Above the sleeve and connecting to the swivel bearing, the invention has its arm 13 that also rotates with the axle.

The arm has a somewhat arcuate shape overall formed of a generally canted L shaped round tubular member. The arm has a leg 14 that operatively connects to the swivel bearing, an upright 15 generally perpendicular to the leg, and a merge 16 of an arcuate form that transitions the upright to the leg. The leg, merge, and upright are hollow for the passage of water there through. The merge generally occupies ninety degrees of rotation in a plane coplanar with the length of the sleeve. The merge begins at approximately a forty five degree angle leftward of the length of the sleeve and ends at approximately a forty five degree angle rightward of the sleeve's length. The merge allows the arm 13 to have a partial S like shape as shown and to offset the arm and generate the wetting pattern as shown in FIG. 1. Outwardly and downwardly from the merge 16 as shown, the arm 13 has the leg 14. Opposite the merge, the leg 14 has a shoe portion as at 19 that connects to the swivel bearing 12b. The shoe portion is generally coaxial with the axle and hollow so that water may enter the leg. Away from the swivel bearing, the shoe portion 19 begins to rotate leftward in the figure to the leg. The shoe portion rotates into the leg until the leg attains a forty five degree leftward angle as shown. The leg then extends outwardly from the length or the axis of the axle to the merge. The merge operates as a transition from the leg to the upright 15. The upright also has a generally hollow, slender, elongated, tubular form. The upright is generally perpendicular to the leg and attains a forty five degree angle, opposite that of the leg, that is, towards the right in the figure. The upright has its length greater than that of the leg as shown. Upwardly from the merge, the upright has a generally solid wall of its tubular form. The solid wall extends for a portion of the upright and generally from the merge to approximately where the upright extends past the axis or length of the axle. Outwardly from the solid wall portion, the upright has its nozzle zone 18. The nozzle zone has at least one nozzles, often a plurality of nozzles, as at 17 machined into the upright. Each nozzle has its geometry to produce the desired stream of water exiting the arm. The nozzle geometries, or edge conditions, include square edge, knife edge, ogee, rounded, and the like. The nozzles have a pattern so that no two nozzles are laterally or longitudinally adjacent. The upright has approximately twenty nozzles spaced every three inches. The nozzles have a common diameter and an edge condition that promotes laminar flow of water from the nozzles out of the invention as shown in FIG. 1. And opposite the merge, the upright has its tip 20. The tip has a generally closed form so that water does not exit from the tip. The tip maintains the water pressure and volume so that the water exits the invention from the at least one nozzle into the desired spray pattern. In a further alternate embodiment, the arm includes one nozzle upon a flexible, hollow member.

The arm 13 has its centroid, or center of gravity, when loaded with water, positioned upon an axis of rotation of the axle. Generally the arm's center of gravity is collinear with the longitudinal axis of the axle. Positioning the arm's center of gravity in this manner provides balance to the arm as it rotates and minimizes vibration and out of design flow paths of the water discharged from the arm. A balanced arm also reduces wear upon all components of the invention beneath it and the motor powering it.

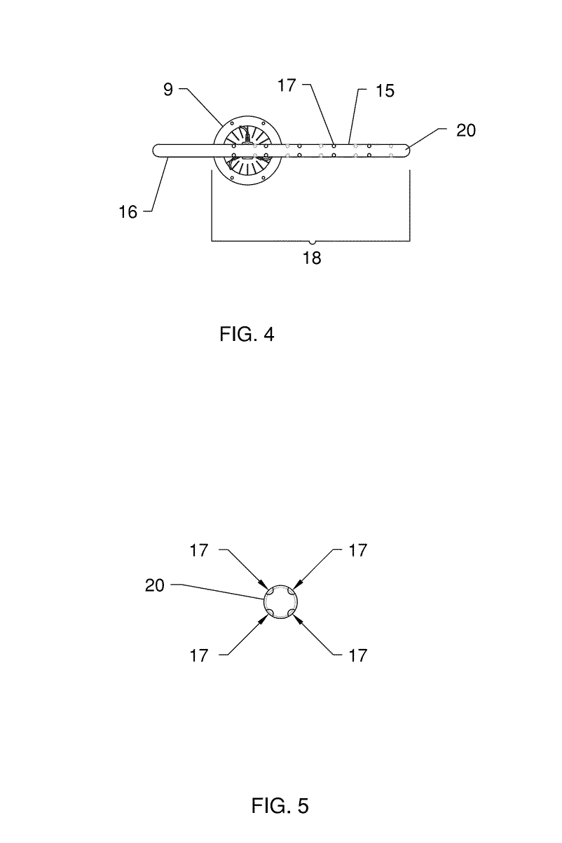

Upon installation, the invention appears from the top as in FIG. 4. From the left in this figure, the invention has its merge 16 that extends towards the right into the upright 15. The upright shows the nozzle zone 18 with two nozzles to the left of the center of the invention, the axle, and the remaining nozzles to the right of the center of the invention. Though the nozzles appear in pairs, the nozzles have a ninety degree spacing along the longitudinal axis of the upright and a forty five degree offset between each pair of nozzles. Outwardly from the nozzle zone, the upright ends in its closed tip 20 to the right most of the figure. Beneath the upright near the beginning of the nozzle zone, the invention shows its base 9 into the background of this figure.

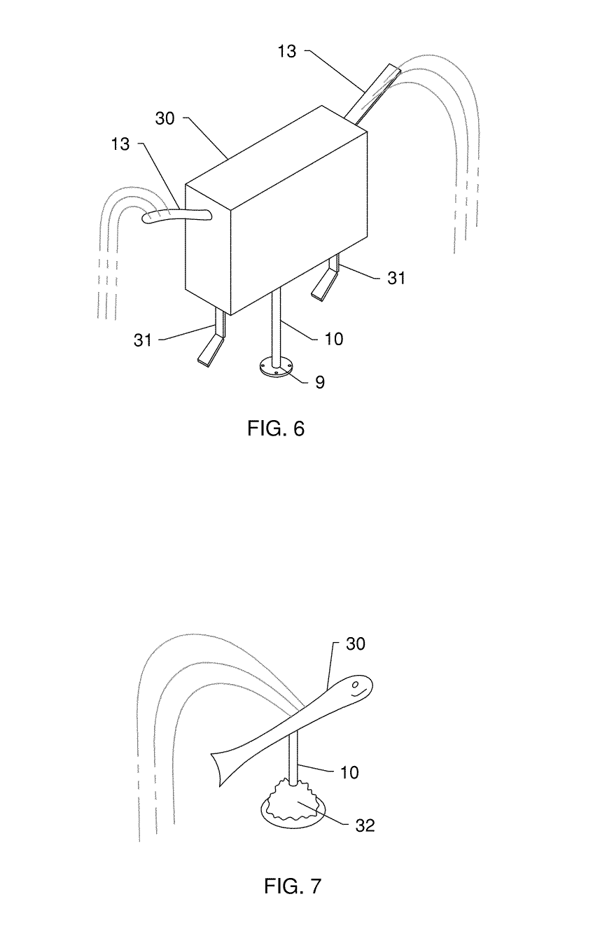

Viewing the tip 20 on end in FIG. 5, the upright has its nozzles 17 arranged in a pattern. The nozzles are arranged in diametrically opposite pairs. Each pair is oriented at forty five degrees to the right or clockwise of the preceding pair. Each pair is then spaced along the upright at an interval of approximately three inches, as previously shown in FIG. 3. Two nearby nozzles have a ninety degrees of rotation separation. This pattern of nozzles sprays, or discharges, water both upwardly and downwardly from the upright with two gangs of streams upward and two gangs of streams downward as shown in FIG. 1.

FIG. 6 shows an alternate embodiment of the invention wherein the arm 13 and sleeve 10 remain concealed within a housing 30 having a shape suitable for the desired location. The shape may take many forms such as a cartoon character, a plant, a truck, a boat, other vehicles, famous people, animals, and the like. The shape in this figure has the arm 13 shown as two components, left and right of the housing. The two components have fluid communication to the sleeve, not shown, which draws water into the embodiment from the sleeve as at 10. Each component of the arm 13 dispenses water outwardly from the housing. This figure shows a shape with two components for an arm and two legs 31. The legs are generally spaced apart and parallel to the sleeve extending from the sleeve 10. This shape fits with many characters and shapes. The shape permits free flow of water as it exits the two components of the arm 13. Select shapes may decorate the components of the arm. That decoration is permitted so long as free flow of water occurs from the components of the arms as shown.

And, FIG. 7 shows another alternate embodiment of the invention. This embodiment also has housing 30 upon the sleeve 10. The housing has its center of gravity generally collinear with the sleeve. The housing to conceals the arm 13, not shown, but permits free flow of water from within the housing. The housing may have various shapes suitable for rotation upon one axis, through the sleeve. The sleeve in this figure extends upwardly from a cover 32 appropriate to the shape of the housing and possibly concealing the base and the motor. The housing has a shape and length, preferably with a slot, that allows water to attain its normal laminar stream like flow from the arm 13 inside the housing.

From the aforementioned description, a rotating spray nozzle has been described. The rotating spray nozzle is uniquely capable of wetting a round planar area from above the height of person and without wobbling during its rotation. The rotating spray nozzle and its various components may be manufactured from many materials, including but not limited to, polymers, polyvinyl chloride, high density polyethylene, polypropylene, nylon, steel, stainless steel, ferrous and non-ferrous metals, their alloys, and composites.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present to invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

1. A device to wet an area, comprising:
a base, said base being planar;
a bearing upon said base;
a sleeve, generally slender, elongated, hollow, and cylindrical, said sleeve having two ends, a lower end and an opposite upper end, said lower end connecting to said base, said upper end having a swivel bearing;
an axle, internally placed within said sleeve and being coaxial with said sleeve, said axle being generally slender, elongated, hollow, cylindrical, and of a diameter less than said sleeve, said axle having a lower end and an opposite upper end and a longitudinal axis;
an arm, generally slender, elongated, and hollow, said arm operatively connected to said upper end of said axle and said arm having a tip away from said connection to said axle;
at least one nozzle upon said arm, said at least one nozzle adapted to discharge water supplied therein;
a motor adapted to rotate upon the pressure and the volume of water from a piped water source, said motor turning said axle;
a housing concealing therein said base, said bearing, said sleeve, and said swivel bearing.

2. The wetting device of claim 1 further comprising:
said arm having a leg, a merge from said leg, and an upright from said merge away from said leg, said leg, said merge, and said upright cooperatively forming a shape.

3. The wetting device of claim 2 further comprising:
said upright having a plurality of nozzles, said nozzles being arranged in a pattern of opposed pairs with each pair being offset in rotation from a preceding pair.

4. The wetting device of claim 3 further comprising:
said upright having a solid wall portion extending left of said axle and said plurality of nozzles extending right of said axle;
wherein upon supply of pressurized water to said axle and to said upright, said arm rotates smoothly about the longitudinal axis of said axle.

5. The wetting device of claim 3 wherein each of said nozzles have an edge condition being one of square edge, knife edge, and ogee.

6. The wetting device of claim 2 further comprising:
said motor is adapted to operate upon from about 10 pounds per square inch to about 60 pounds per square inch water pressure.

7. The wetting device of claim 2 further comprising:
said leg, said merge, and said upright cooperatively forming a canted L like shape.

8. The wetting device of claim 1 further comprising:
said arm being flexible and said at least one nozzle connecting to said arm at said tip.

9-10. (canceled)

11. A rotating spray device upon an area, comprising:
at least one nozzle adapted to discharge water supplied thereto;
an arm, generally slender, elongated, and hollow, said arm having at least one nozzle therein and a tip;
a swivel bearing operatively connected to said arm opposite said tip;
an axle, being generally slender, elongated, hollow, cylindrical, and said axle having a lower end and an opposite upper end and a longitudinal axis, said upper end operatively connecting to said swivel bearing;
a sleeve, generally slender, elongated, hollow, and cylindrical, said sleeve having two ends, a lower end and an opposite upper end, said upper end operatively connecting to said swivel bearing, said sleeve being externally placed outwardly of said axle and being coaxial with said axle, said sleeve of a diameter more than said axle;
a bearing beneath said sleeve;
a base, generally planar joining to said bearing, said lower end of said sleeve connecting to said base;
said arm having its center of gravity being collinear with said longitudinal axis when loaded with water; and,
a housing concealing therein said base, said bearing, said sleeve, and said swivel.

12. The rotating spray device of claim 11 further comprising:
said arm having a first component and a second component in fluid communication with said sleeve, said first component and said second component extending outwardly from said housing.

13. The rotating spray device of claim 11 further comprising:
said arm extending outwardly from said housing.

14. A device to wet an area of a location, comprising:
a base, said base being planar;
a bearing upon said base;
a sleeve, generally slender, elongated, hollow, and cylindrical, said sleeve having two ends, a lower end and an opposite upper end, said lower end connecting to said base, said upper end having a swivel bearing;
an axle, internally placed within said sleeve and being coaxial with said sleeve, said axle being generally slender, elongated, hollow, cylindrical, and of a diameter less than said sleeve, said axle having a lower end and an opposite upper end and a longitudinal axis;
an arm, generally slender, elongated, and hollow, said arm operatively connected to said upper end of said axle and said arm having a tip away from said connection to said axle, said arm having a leg, a merge from said leg, and an upright from said merge away from said leg, said leg, said merge, and said upright cooperatively forming a canted L like shape, said upright having at least one nozzle, said upright having a solid wall portion extending left of said axle and said at least one nozzle extending right of said axle; and,
said at least one nozzle being adapted to discharge water supplied therein and each of said at least one nozzle having an edge condition being one of square edge, knife edge, and ogee, said nozzles being upon an about three inch spacing;
a housing concealing therein said base, said bearing, said sleeve, and said swivel bearing;
a motor adapted to operate upon the pressure and the volume of water from a piped water source, said motor turning said axle;
wherein upon supply of pressurized water to said axle and to said upright, said arm rotates smoothly upon the longitudinal axis of said axle.

15. The area wetting device of claim 14 further comprising:
said arm having a center of gravity collinear with said longitudinal axis when said device is loaded with water.

16. The area wetting device of claim 14 further comprising:
said upright having at least four nozzles being arranged in a pattern of opposed pairs with each pair being offset in rotation from a preceding pair.

17. The area wetting device of claim 14 wherein said motor is adapted to operate upon from about 10 pounds per square inch to about 60 pounds per square inch water pressure.
